(19) United States
(12) Patent Application Publication
(10) Pub. No.: US 2008/0159530 A1
(43) Pub. Date: Jul. 3, 2008

(54) Gadget to encrypt and keep account login information for ready reference

(76) Inventor: Mehran Randall Rasti, (US)

Correspondence Address: MEHRAN RANDALL RASTI, 13040 SUGAR BOWL AVE., BATEN ROUGE, LA, 70814, US

(21) Appl. No.: 11/561,444

(22) Filed: Nov. 20, 2006

(51) Int. Cl. G09C 3/08; H04L 9/00

(52) U.S. Cl. 380/51; 713/189

(57) ABSTRACT

The invention introduces a stand-alone small electronic device that provides the means for computer users to encrypt and keep their everyday confidential account login information in an indexed notebook or stored in a removable memory module for easy reference. Such account information includes User-Names, passwords, secret questions, and secret answers to those questions. This eliminates the risk of confidential account information exposure, should the storage media gets lost, stolen, or misplaced. Account login information are entered as separate character-strings into the device and are encrypted by using software that makes use of a “Master Password” phrase/character-string as an “Encryption-Decryption-Key”. The Master Password is a phrase or a combination of words, characters, and numbers a user can easily remember. Unlike a personal computer that is attached to networks, the stand-alone device is not connected to a network or the internet in a way to jeopardize user account information confidentiality.

### CROSS REFERENCE TO RELATED APPLICATIONS

| U.S. Pat. No.: | Date: | Inventor: |
|---|---|---|
| 6,172,688 | Jan. 09, 2001 | Iwasaki, et al. |
| 6,384,931 | May 07, 2002 | Brown, et al. |
| 4,779,105 | Oct. 18, 1988 | Thomson, et al. |
| 4,875,174 | Oct. 17, 1989 | Olodort, et al. |

### FEDERALLY SPONSORED RESEARCH OR DEVELOPMENT

Not applicable

### REFERENCES TO SEQUENCE LISTING, TABLE, OR COMPUTER PROGRAM TABLES

None

### Computer Programs

An encryption/decryption program consisting of 6 program modules has been included in 6 text files for demonstration purposes only. The supplied program has been crafted for execution on a web server that is capable of executing simple ASP (Active Server Pages version 2) code without the need for compilation; thus making it easy to run and demonstrates the concept over the internet. However, the production versions of the code should be more robust and compact; In addition such code needs to be in compiled from so that it can be transferred over onto removable memory modules in binary format or be burnt into the gadget's internal memory (EPROM) chips.

The supplied demonstration program spawns over 6 modules in 6 text files as follows:
1. EncDecStrA2_asp.txt: This file contains the program named “EncDecStrA2.asp” that is abbreviation for “Encrypt/Decrypt String Module-A, version 2”. This program module presents the opening data entry screen for the web server version of the demo program. The function of this program is to collect from the user the following input comprising
   a) A flag value indicating to encrypt or decrypt;
   b) A string of characters to be encrypted or decrypted;
   c) a second string of characters to be used as the encryption and subsequent decryption key. This is named as “Encrypt-Decrypt-Key”, or “Master Password”. Master Password refers to a password phrase, number, and words a user can recall easily and seldom changes.
2. EncDecStrB2_asp.txt: This file contains the program named “EncDecStrB2.asp” that is abbreviation for “Encrypt/Decrypt String Module-B, version 2”. This program module does the following tasks:
   a) extracts the 3 data items collected and passed-on by the previous module (EncDecStrA2.asp);
   b) checks for data lengths and edits such data for integrity and;
   c) if needed, issues related error messages by calling the ERROR1 module of the program set;
   d) detects if the user has indicated encryption or decryption;
   e) if decryption, it passes the two collected character-strings to module-C (EncDecStrC2.asp) for decryption;
   f) if encryption has been requested, then it encrypts the input character-string using an algorithm similar to the one presented based on the supplied “Encrypt-Decrypt-Key” that had been input by the user as his/her Master-Password as the encryption key foundation (basis).
3. EncDecStrC2_asp.txt: This file contains the program named “EncDecStrC2.asp” that is abbreviation for “Encrypt/Decrypt String Module-C, version 2”. This program module does the following tasks:
   a) extracts the 2 data items passed-on comprising the character-string to be decrypted and the “Encrypt-Decrypt-Key” to serve as the decryption-key, as has been passed on by the previous module (EncDecStrB2.asp);
   b) checks for data lengths and edits such data for integrity and;
   c) if needed, issues related error messages by calling the ERROR1 module of the program set;
   d) decrypts the supplied character-string by using similar to the one presented based on the supplied “Encrypt-Decrypt-Key” that had been input by the user as his/her Master-Password as the decryption key foundation (basis).
4. Error1_asp.txt: This file contains “Error1.asp”; a function that is called when an error occurs. The program calling this function supplies an error-number, and an error-text to this function, causing these variables to pop on the screen and to inform the program user for corrective action.
5. RemDQuotes_asp.txt: This file contains “RemDQuotes.asp”; a function that is called to take out any Double-Quote-characters that the user may have included in any of his/her input-strings. The program language that this demo program uses has been written in VB Script and it uses the double-quote character as string-delimiter. This deficiency may be overcome using more advanced programming techniques or by using other programming languages such as C, or C++ in production versions.
6. Basic1_css.txt: This file contains “Basic1.css”; a “Cascading Style Sheet Include File”. Similar code is used in web-bound programs to format the text and to set various type-faces, font-sizes, font-colors, and the like.

### BACKGROUND OF INVENTION

1. Field of Invention

The invention provides the means for computer users to be able to encrypt and record their everyday login account information such as User-Names, passwords, secret questions, and secret answers to those questions into an indexed notebook or removable memory in encrypted format for reference, without running the risk of exposure, should they loose the storage media, or if it is stolen or misplaced.

2. Status of Prior Art

Proliferation of computers into our everyday life, the widespread use of the internet almost in every household on one hand, and the incentive of banks, insurance companies, credit card companies, utility companies, and the like to save money in encouraging their customers to use provided services online on the other, has created a new problem; almost everyone has to remember a multitude of user-names, passwords, and logon-id information of sorts. The task of remembering the user-name and passwords, its required format restrictions, URLs of these companies, and the like has become a chore for some, and a difficult task for many others; almost every company and institution have their own rule of acceptable user-name and password formats, lengths, and such requirements as having to have a capital letter here and there, with or without a special characters, and other variety of hard-to-remember rules. They also have their own list of secret questions they provide for you to answer if you forget your password and want to retrieve it that is different from every other company.

Of course having only one password, and one set of question/answer does not work, and even if it did, it would have been against good security practices of using computers. On the other hand, having a few of different logon-ids and passwords becomes even harder to remember when they must be changed from time to time, and when a company changes its login format rules or URLs (web site names). One common method people use, is to write their login information here and there. Sometimes they forget where they wrote it, and would not be able to access it when needed. I have seen people write their login information on the back of business cards, on paper stuck around their computers, cork boards, on office walls, and under their desks. All such writings can be discovered and read by unauthorized eyes of visitors at home, as well as cleaners and coworkers in the office. Writing passwords in un-encrypted format in a note-book makes it even easier to steal it all in one shot!

There are some web sites on the internet providing encryption of text, even an entire email. One problem with these sites is lack of user trust; after all, such sites store peoples' most sensitive account information, and in the best scenario the owner and/or the system administrator of such sites would have the ability to decrypt and view such sensitive account login information and possibly be tempted to take advantage for personal gain.

Another obvious way is to use a personal computer and to run the same encrypt/ decrypt routines on a PC. If a computer would be a standalone station and not connected to a network or internet this would be a practical solution. However, with the abundance of countless spy-ware, Trojan-horses, and variety of mal-ware, and since most computers are connected to the internet or are networked and have more than one user, it would be a rather unsafe place to keep such sensitive information. When attempting to use and log into account with such information, the user has to make sure that he/she is connected to the internet through Secure Socket (https://), or a similar secure protocol.

The stand-alone small electronic gadget that is introduced in this document resembles a portable label-printer now in the market place, but has the added capabilities to encrypt and decrypt text and character-strings supplied to them with plenty of I/O ports for interfacing to variety of input-output gadgets and devices. Unlike personal computers this is a small and handy unit. It can be carried in a briefcase to work or when traveling, and can be stowed in a desk drawer when at work or at home. In contrast, PCs are bulkier and more prone to exposure.

### SUMMARY OF INVENTION

The invention serves to facilitate computer users who have to access several accounts on the internet to have a safe way of recording their account and login information, in encrypted format, in a notebook, or a portable memory module. Such a storage media can be backed up and provides a central place to keep such information. A user is able to decrypt the supplied login information using one Master Password that he/she can easily remember. If a note-book is used in conjunction, the encrypted login information are first printed on self-adhesive, narrow, labels and then are glued in alphabetically indexed note-book (Pass-Book) for handy reference.

The encryption method used in such a device is not a fixed translation. For example, the software does not always encrypt the letter “a” to “K”. The encryption method is dependant upon a secondary character string that a user enters as an “key”, on the basis of which an encryption takes place. We refer to such a “key” as the “Encryption-Decryption-Key”, or a “Master Password”; one that a user can remember and always enter at encryption as well as decryption time. One example of such a Master Password would be: “The dog 8 my lunch!”. Of course, the same “Master Password” should be typed-in, when decrypting an already encrypted character-string, or else the original words/character-string would not result.

The encryption/decryption algorithms also employ numerous differently sequences-constant-character-strings in their design to create variations in the algorithm used. The gadget has the option of accepting such sequenced-constant-character-strings from outside through its I/O port. Extra sets that can be purchased as “different keys” are in the form of (flash) memory modules or plastic-smart-cards/cartridges. This provides a secondary key, so that not all gadgets sold would encrypt/decrypt the same character-strings when supplied with the same Master-Passwords.

The stand-alone electronic gadget:
1. Has a hardware or software driven mode-switch to set the mode of operation for the gadget to encrypt, decrypt, or do a straight-through-output (no translation).
2. Is capable of accepting input from the user, when supplied through a keyboard, keypad, and/or an I/O port. One can plug-in a removable memory module, a scanner, or an interface adapter to the device's I/O ports.
3. Has a minimum of 512 bytes of memory-buffer to capture, and store character-strings and data input in steps 1, and 2, above, and to pass those to the device processor.
4. Has additional memory, large enough to load all program algorithms, software-code and data required for encryption and decryption routines to execute, and to also furnish the needed page-in page-out memory needed for I/O operations to the CPU as well as its I/O buffers.
5. Has enough CPU processing power to accept input from the input-buffer, load and execute program code and data from memory buffers in steps 2, 3, and 4, above.
6. Has enough CPU processing power, and memory to process and format information bound to output buffers; to load and execute routines needed for the execution of the device's display-driver, printer-driver and other device drivers that are necessary for the operation of the gadget's I/O ports.
7. Has enough memory to be used as output-buffer-memory for storing the output content as it is managed and passed on to the output display, printer, and I/O ports.
8. Has a screen to display, and/or a printer, printer-port, and at least one additional output port to accommodate a pluggable memory, and/or other interfaced adapters in order to connect the device to a PDA, another gadget, or a computer for the entry of decrypted user-name with password for automated login.

### DESCRIPTION OF THE DRAWINGS

FIG. 1: Flow diagram of encryption/decryption operation. This diagram shows the logical software flow for the encryption/decryption operation.

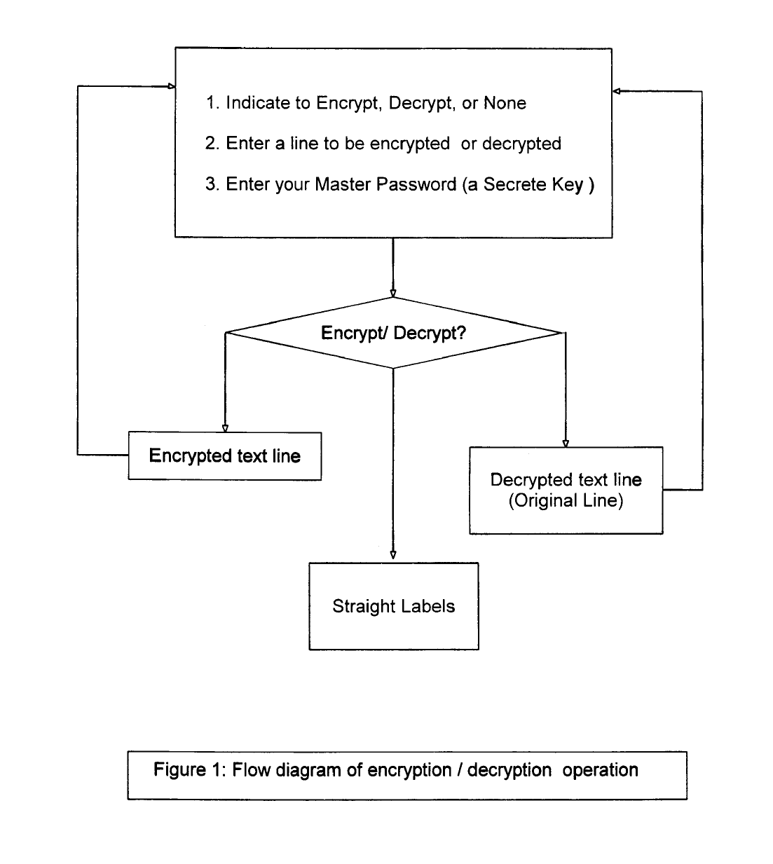

FIG. 2: Device data flow between its modules. This diagram shows the device hardware components and data flow path among these modules.

### DETAILED DESCRIPTION

The invention specifies a small electronic device to capture, encrypt, and later on to decrypt a word, phrase, or combinations of letters, numbers, and printable special characters, based on a second character-string used in the encryption/decryption algorithms functioning as an integral part of the “Encryption-Decryption-Key”. To a user of the device, the Encryption-Decryption-Key is a “Master Password” he/she can easily remember and can always type-in to reverse an already encrypted string into its original/decrypted state.

While a personal computer armed with the proper encryption/decryption software can accomplish a similar task, a small, self-contained device such as the one specified in this document would provide the following unique advantages:
a) The device is not connected to the internet in a way that spy-ware, worms, Trojan-horses, and computer viruses are able to get in. As we are well informed, such mal-ware would cause the leakage of confidential account information to the outside world. On the other hand, input, encryption, and storage of confidential account and login information on a personal computer exposes the user to the possibility of information leakage to outside spies; whether the programs and data are held within the PC or on some internet site.
b) The device is a portable electronic gadget that can be carried in a brief case or kept in a desk drawer for easy-reach, and accessibility when needed.
c) The device can print the encrypted login information on narrow self-adhesive labels to be glued in an indexed notebook.
d) The device, through its I/O port can store already encrypted login information in removable (flash) memory modules, and/or in the device's internal memory in the absence of the “Encryption-Decryption-Key” used.
e) The device can be incorporated as an add-on to unit to a cell-phone, music-box, or other handy/carryon personal gadgets to be readily accessible to its users.

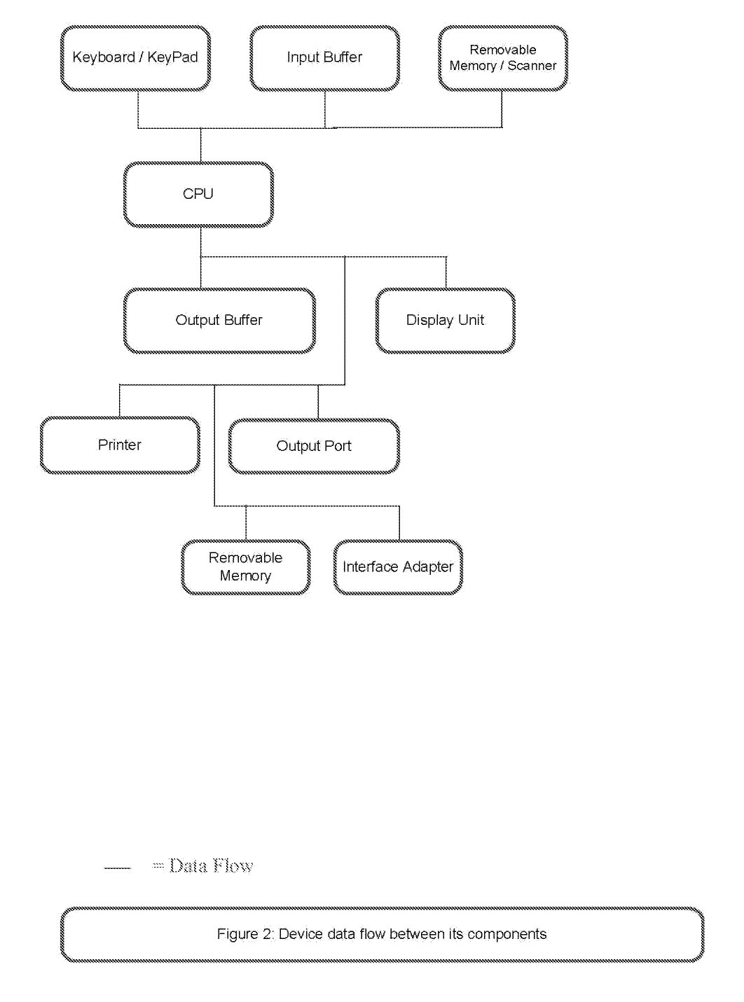

The device comprises the following components:
1. A 3 way mode hardware switch that dictates the mode in which the device is going to function. The tree selectable mode positions on the switch are:
   a) Encryption
   b) Decryption, or
   c) Label: This is for when a user should want to print straight text such as an institution-name, its URL (web address), or just wants use the device to print straight text on sticky-labels to later on glue it in his/her password-note-book. For example, the name of a bank or a utility company for which the encrypted logon information is to follow in a page of such a “Pass-Book”.
The mode-switch settings of the hardware switch can be overridden by a software mode setting in cases where the supplied software provides such a functionality choice to the user. Such software should provide the 3 mode choices mentioned above, or the two choices of encryption or decryption at its minimum configuration.
2. One to four (USB) I/O ports for plugging-in removable memory modules, a scanner, and/or a keyboard/keypad for when the device is not equipped with a keyboard/keypad of its own. Such I/O ports can be put to use for the following functionalities:
   a) An I/O port to connect to an outside keyboard/keypad, to a PDA, or another device that supplies shared resources.
   b) An I/O port that is capable of accepting a (USB) removable memory module containing pre-stored and encrypted logon information, without storing the user's Encryption-Decryption-Key (user Master Password).
   c) An I/O port to connect to a scanner to accept its input.
   d) An I/O port capable of accepting (USB) removable memory modules or cartridges that contain pre-recoded encryption/decryption data string constants and algorithms. This is to vary the outcome of encrypted/decrypted output between the devices in use by different people having purchased the same model number.
3. Optionally, and in addition to the above, the device can incorporate a self contained keyboard, keypad, or other types of input source. The input is managed by device-driver-programs that are specially written for managing a particular device type.
4. A device-driver reads and directs data from input ports into the input-memory-buffer in segments to be passed on to memory buffers and registers of the CPU (Central Processing Unit). Device drivers communicates with the I/O buffers and CPU memory and registers to fetch-in the input data in chunks for processing See FIG. 2, device data flow diagram.
5. The device-drivers are mini-programs that themselves need a working space and memory to run. Such resources are usually provided by the central processing unit (CPU).
6. The operations of the CPU itself, requires additional memory. Therefore, in addition to memory for I/O buffers, the device needs to contain extra memory for the processing of programs in the CPU. This memory is built-in both inside the boundaries of the CPU chip, and also outside the perimeters of the CPU chip on the circuit board. This memory is also used for page-in/page-out operations involving binaries traveling between CPU registers and storage buffers.
7. The CPU loads the program binary code in segments into its various registers and memory buffers and executes these segments managed by its internal clock. Most of the CPU operations occur in pre-defined clock cycles (time pieces) of the internal clock. These are called interrupts and are numbered by the order by which the inter-related duties are performed. At some small time interval the CPU is ordered to read a data segment from the input-data-buffer and to load its segments into a register location for processing.
8. The data in that register gets operated on by values in other pre-designated registers of the CPU. The CPU works on the input-string data as it is made available by the device drivers managing the I/O from the input-memory-buffer to the CPU's own memory-buffers in accordance to the program code supplied. As such, pieces of output are made ready and are sent to output-memory-buffers for output. There are also some output-device-drivers running in CPU that manage the output; to properly format it for the particular output device that at the time is connected to a certain I/O port. Several output-device-drivers may be running at the same time. One to direct output to display, another one to drive a printer, and yet another one may manage I/O to prepare the output for storage in a removable memory.
9. An advanced input/output (I/O) port, such as a USB port has the required logic to be able to read the data specific to the kind of a device that is attached to it to configure itself by negotiating configuration information between itself and the connected I/O device. These technologies are all currently being utilized in the computer hardware/software technologies and any further discussion is out of the scope of this document. The bottom line is that the USB and device-driver firmware are all readily available in the market in the form of prefabricated functional chips that can be readily incorporated in a circuit design by engineers in this profession.
10. It is possible to request into execution another device-driver to manage I/O to and from an interface-card-adapter that is in turn connected to an external device such as a PDA or a PC. Using the device driver, an I/O port is able to furnish output to the secondary device. This enables a user to be to pick and select his/her choice of logon information, and to login to an account by redirecting already decrypted logon information from the gadget to the secondary device.

### Software Specifications:

1. The machine's software is loaded into the device ROMs in precompiled or “.com” format at the manufacturer. The encryption/decryption program code is also pre-compiled in binary format and is small enough to fit into machine's ROMs, and to execute within the confines of available RAM.
2. The string-constants within the program that govern the encryption rules and keys, originate and are loaded from outside the machine through its I/O ports. Using a device-driver, the machine is instructed to read these strings out of some pre-fabricated removable-memory-modules, and pluggable cartridges/smart cards. The manufacturer makes available such removable-memory-modules/smart cards so that the stored-data with which the built-in encryption and decryption routines interact, would vary and would provide a form of a “key-to-the-machine”. “Machine Keys” cause different machines to encrypt and translate the same character-strings entered with the same Master-Passwords to render different instances of the translation method. This enhances the security of such machines in that not all machines would render the same character-string when supplied with identical character-strings, and identical “Encryption-Decryption-Key” (Master Passwords).
3. The minimum and maximum range for the length of string-characters to be encrypted/decrypted is governed by prevailing rules for forming login user-names and password. This is currently specified at the minimum of 4 and the maximum of 255 characters. A user-friendly password length range is commonly set between 4 and 25 characters.
4. Characters acceptable for input should exist on a computer keyboard and designated as printable characters in the language and country settings for which the device is made and marketed. These characters consist of those that are also acceptable as “user-name” and “password-characters” in a given language and keyboard-map setting. Acceptable characters for the “Encryption-Decryption-Key” (Master Password) can be any type-able character on the device's keyboard/keypad.

NOTE: In this entire document, the terms “login”, and “logon” are used interchangeably; also the terms “login-id”, “logon-id”, “user-id”, and “user-name” convey the same meaning.

PURPOSE OF THE INVENTION is to have a dedicated electronic gadget to input, encrypt, store, decrypt, and use a multitude of computer account login information in a ready-to-use place and in a rather safe encrypted format. The strength of the encryption depends largely on the supplied algorithms that may partially or fully be supplied in the form of cartridges, smart plastic cards, and/or removable (USB) memory modules plugged into the gadget.

I claim:

1. An electronic gadget comprising
a. data entry facility such as keyboard, keypad, and I/O port,
b. a three-mode function switch to set the mode of the gadget's output to encrypt, decrypt, or unmodified,
c. processor and memory chips to accept, display, print and output the resulting character-string,
d. processor and memory chips capable of reading and running special software to encrypt and decrypt input character-streams for output,
e. hardware to display, print, and output the resultant character-string in encrypted, decrypted, or unmodified form.

2. The electronic gadget in claim 1 in which a pluggable memory stick or cartridge serves as a source of input.

3. The electronic gadget in claim 1 in which the output is directed to an I/O port with, or without a memory device attached.

4. The electronic gadget in claim 1 in which the output is directed to a printer on which the unmodified input-character-string, and/or its encrypted or decrypted character-string representations are inscribed on narrow self stick adhesive label strips that are later on glued into an indexed notebook for future reference.

5. The electronic gadget in claim 1 in which the input and output devices are built into the electronic gadget in one embodiment.

6. The electronic gadget in claim 1 in which the input and output devices are external devices interacting through the gadget's I/O ports.

7. A standalone device such as a cell-phone, PDA, or similar portable device with an electronic gadget in claim 1 built in one embodiment possessing the same functional capabilities as a device in claim 1.

8. The electronic gadget in claim 1 in which the input and output devices are attached to a personal computer, PDA, cell phone, and similar devices communicating via wired or wireless means or through the internet.

9. Software in claim 1 is fully or partially built into the gadget and has the functionality to
a. accept entries from any of the I/O ports and devices attached to the gadget in claim 1;
b. read in a hardware or a software setting to set its mode of operation to encrypt, decrypt, or unmodified;
c. accept from its input source, a key-character-string to be used as the “Encryption-Decryption-Key”/Master-Password;
d. accept from the device input source, a string of characters to be encrypted or decrypted based on the said Encryption-Decryption-Key;
e. output the resultant character-string to screen, printer, I/O port, or their plurality.

10. The electronic gadget in claim 1 in which software segments or components are external to the gadget, all or parts of which are loaded through input/output ports, and devices.

11. The electronic gadget in claim 1 in which encryption/decryption data and software components containing pre-recorded logic and encryption-decryption code are supplied through plug-in memory cards and/or smart cards.

12. A “Password-Reminder-Notebook” of encrypted logon ids, passwords, and other secret words and phrases to remember, is made by
a. encrypting the original character strings of such secret words;
b. printing the encrypted character strings on strips of sticky labels;
c. cutting, and gluing such sticky labels onto indexed pages of such a “Password-Reminder-Notebook”, and
d. when needed, decrypting the previously encrypted character-strings into their original state by using the same encryption key and reverse algorithms that encrypted them.
